(19) United States
(12) Patent Application Publication
(10) Pub. No.: US 2015/0128218 A1
(43) Pub. Date: May 7, 2015

(54) SYSTEM AND METHOD FOR RESTRICTING INTERNET ACCESS

(71) Applicant: Brett R Vogel, Salida, CO (US)

(72) Inventor: Brett R Vogel, Salida, CO (US)

(21) Appl. No.: 13/517,173

(22) PCT Filed: Sep. 26, 2011
(86) PCT No.: PCT/US11/53281

§ 371 Date: Jun. 19, 2012

(51) Int. Cl. H04L 29/06

(52) U.S. Cl. CPC H04L 63/101
USPC 726/4

(57) ABSTRACT

A system and method for controlling access to the Internet is presented. By reserving a selected generic top-level domain, controlling content placed on subdomains within the selected generic top-level domain, and utilizing an Internet browser program that is specially modified to limit browsing to within the selected generic top-level domain, access to a sharply-defined and controlled subset of the Internet is achieved.

### REFERENCE TO RELATED APPLICATIONS

Not applicable.

### ACKNOWLEDGMENT OF GOVERNMENT SUPPORT

Not applicable.

### BACKGROUND OF THE INVENTION

1. Field of the Invention

The invention pertains to the field of software and methods for limiting access to the Internet. More particularly, the invention pertains to a system for creating a safe Internet browsing, working and playing environment by controlling a generic top-level domain (gTLD), including policing the content available through the gTLD, and disseminating an Internet browser that only permits viewing and interacting with content from the gTLD.

2. Description of Related Art

Since the mid-1990's, the Internet has had an ever-increasing impact on culture and commerce. Nearly instantaneous communication by electronic mail, instant messaging and access to vast stores of information and entertainment content, social networking and online shopping through the World Wide Web have changed society in myriad ways.

Controlling and limiting access to undesired and/or inappropriate content has been a constant problem. Parents may wish to prevent access to sexual and other objectionable content by impressionable children. Employers may want to limit or prevent access by employees to social networking and other web sites that divert time, attention, and IT resources away from productive business pursuits. At the same time, employers wish to make information available to employees to assist them in performing their jobs.

Kiosk-type applications are another area where controlling and limiting access to the Internet is a desired goal. Merchants may want to provide information access to customers to help them make intelligent purchasing decisions, but neither want to create a dedicated information server network nor allow the expensive kiosks to be used for idle browsing of Internet sites that, in some cases, can cause the local computers to become infected with malware and viruses.

The prior art is rich with inventions to control and limit Internet access. Nearly all employ one or a combination of three methods. The first method is a “whitelist”, where only Web sites whose URLs (Uniform Resource Locators) are contained on a pre-established list can be accessed by a browser. Another method is a “blacklist,” where pre-identified URLs containing undesirable content are blocked by the browser. And finally, some inventions analyze the content of an accessed website to match keywords prior to display of content to a user. If keywords on the list are found, access to the Web site is blocked. All of these methods are extremely labor-intensive and require constant maintenance. If the lists are not continually updated, access to non-objectionable content can be blocked, and access to objectionable content may be allowed. Motivated by positive or negative intentions, users frustrated by inability to access blocked content may seek ways to circumvent content controls. In addition, undesirable picture content is nearly impossible to automatically detect and block, and must be added manually, which means it is always added after some period of un-blocked access.

### SUMMARY OF THE INVENTION

The present invention overcomes all of these obstacles. In effect, a virtual private browsing network is created that limits users of the system from browsing outside of a selected gTLD. The invention, when implemented, provides access to a sharply-defined subset of the Internet by controlling both ends of the content transport chain.

Present Internet access methods incorporate a browser program, which is a software program running on a personal computer, smartphone, or other information appliance that manages the access through the Internet by coordinating the conversion of a URL to the Internet Protocol (IP) address that is used to connect and access the desired content represented by the URL, and then displaying the accessed content. The invention requires the acquisition and control of at least one unique generic top-level domain (gTLD), and the dissemination of a browser that restricts access to content solely contained on the at least one gTLD.

### BRIEF DESCRIPTION OF THE DRAWINGS

FIG. 1 illustrates a greatly simplified view of the World Wide Web environment in which an embodiment of the invention operates.

FIG. 2 illustrates an example of HTML code processed by a web browser.

FIG. 3 is a view showing an example of a web browser in which an embodiment of the invention operates.

### DETAILED DESCRIPTION OF THE INVENTION

In 2010, the Internet Corporation for Assigned Names and Numbers (ICANN) completed plans to allow registration of generic top level domains selected by users. During the past decade, while ICANN had introduced several new gTLDs (e.g., .aero, .biz, .coop, .info, .museum, .name, .pro in 2000; and .asia, .cat, .jobs, .mail, .mobi, post, .tel, .travel, and .xxx in 2003), it found in July 2007 that 75% of domain name registrations were still concentrated in seven of the TLDs, including .com, .net, and .info. ICANN decided against continuing a policy of structured taxonomy, and instead to allow potential applicants to self-select gTLDs that are either most appropriate for their customers or potentially most marketable. The previous two rounds of experience of implementing new gTLDs indicated there were no technical impediments to introducing even large numbers of gTLDs, and that internationalized domain names (IDN) using characters other than Latin (i.e., the letters a-z and numbers 0-9) were possible and desirable.

The first round of registrations of new gTLDs is scheduled to open on Jan. 12, 2012, and close on Apr. 12, 2012 and presents an opportunity for companies to create optimized and closed Internet browsing environments. Instead of restricting browsers to “whitelisted” sites, blocking “blacklisted” sites that have been found to contain undesired content, or analyzing requested content for objectionable keywords, companies may now create their own sharply-defined browsing environment built around a new gTLD. Such sites may include pages available to the general browsing public using unrestricted, commercially-available browsers, as well as password-protected and secure sites using the HTTP Secure protocol for registered customers and employees using both unrestricted browsers and restricted browsers according to the invention.

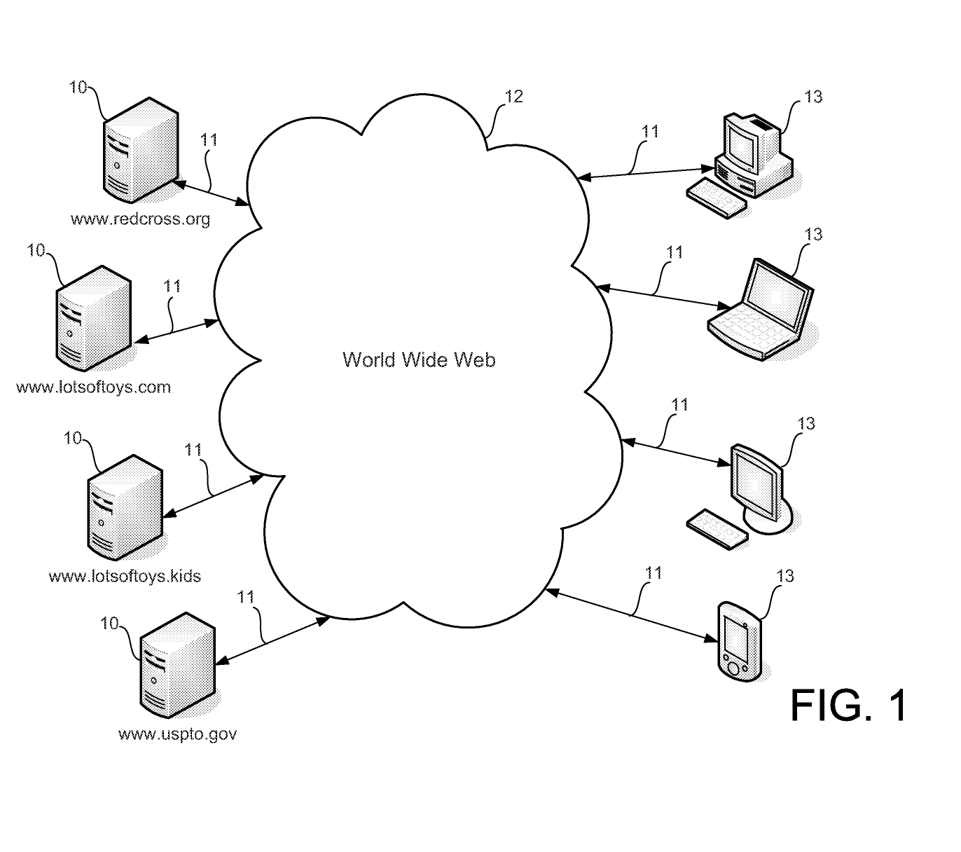

FIG. 1 illustrates the Internet environment in which the invention operates. Multiple servers 10 communicate through data connections 11 through the World Wide Web using Hypertext Transfer Protocol (HTTP) in response to requests made by clients 13 using Internet browser programs. As is well-known in the art, the “Internet” refers to the global network of clients and servers, while the “World Wide Web” refers to the parts of the Internet that provide access to Web pages and other content using the HTML protocol. Since it is rather unwieldy to use the term “World Wide Web browser,” for the purposes of the invention, we will use the terms interchangeably.

Although only a handful of clients and servers are depicted in FIG. 1, it is well-known that the Internet consists of millions of servers and perhaps billions of clients. Clients using Internet browsing software may be desktop computers, laptops, or even mobile devices such as smart phones. The present invention is applicable to any client using Internet browsing software.

In a preferred embodiment, the invention is comprised of first obtaining registration of a selected gTLD for which restriction is desirable; for example, .kids. When registration is obtained, the registrant will henceforth control what content is placed on the selected gTLD. The registrant can either establish servers containing the content available at the selected gTLD, or can permit applicants to establish second-level domain servers on the selected gTLD containing approved content. If the registrant permits applicants to establish second-level domain servers using the selected gTLD, it in effect becomes the registration authority for the selected gTLD. Alternatively, the registrant may be a consortium of content providers that establish policies all content providers must follow in order to be able to establish second-level domain servers that make content available on the selected gTLD.

In a preferred embodiment, the selected gTLD registrant will permit companies who wish to place content on the gTLD to register second-level domains. Using the .kids example above, one potential sub-registrant will be permitted to obtain the second-level domain lotsoftoys.kids, on which it will place the World Wide Web server www.lotsoftoys.kids to provide content through the World Wide Web requested by clients using Internet browsing software. The gTLD registrant will place two restrictions on the content placed on the www.lotsoftoys.kids website. First, all of the content on www.lotsoftoys.kids must meet requirements established by the gTLD registrant. In the .kids example, this would be content suitable for viewing by children of any age. Second, all of the content on www.lotsoftoys.kids must be accessible from the www.lotsoftoys.kids server. There can be no hyperlink or other references within the content to sites outside the .kids gTLD. The reason for this restriction is that the browser will not permit any content outside of the selected gTLD to be displayed.

The final element of the invention is an Internet browser program that is similar in all respects to commonly-available Internet browsers in all respects except two. In a preferred embodiment, the first difference is in the way that the browser processes Internet addresses entered for browsing. The Internet browser program will be altered so that if the address entered into the browser's address bar does not end in the selected gTLD (.kids), then the browser will not navigate to, nor display, the website corresponding to the entered address. In a preferred embodiment, the browser may display a warning message box within the program, or alternatively navigate to a warning page similar to a “Page not Found—404 error” page commonly displayed by an Internet server when a page corresponding to an entered address or hypertext link contains an address that cannot be found on the Internet server.

The second difference of the Internet browser program of the invention from commonly-available Internet browser programs is that, in a preferred embodiment, the Internet browser program of the invention parses the Hypertext Markup Language (HTML) code received from the Internet server to ensure that all content received from the selected .kids page is contained within the .kids domain. Commonly-available Internet browsing programs receive HTML code which may contain links and image content stored on other sites. For example, the HTML tag <img> embeds an image into the selected page. Normally, the browsing program will retrieve the content regardless of the URL specified for the image location. However, in a preferred embodiment, the Internet browsing program of the invention will determine if the URL specified in the <img> tag ends in .kids, indicating the content is actually located on a .kids server.

Using the lotsoftoys.kids example, a page on the lotsoftoys.kids server may contain an image tag similar to the following:
<img src=“wondertoy.gif” alt=“The Wonder Toy”>

The “src” parameter specifies the URL for the image to be displayed. In the example above, the URL is a “relative” URL which would be located on the lotsoftoys.kids web site. Both a commonly-available Internet browsing program and the Internet browsing program of the invention will allow this image to be displayed.

Another image tag on the lotsoftoys.kids server may read as follows:
<img src=“http://www.lotsoftoys.com/wondertoy.gif” alt=“The Wonder Toy”>

While the commonly-available Internet browsing program will retrieve and display the image located at the URL in this image tag, in a preferred embodiment, the Internet browsing program of the invention will detect the .com portion of the URL identifying the location of the image as outside of the .kids gTLD, and will not retrieve or display the image. A “broken image” icon, or a message indicating the image cannot be displayed, may be placed in the area of the page that would contain the prohibited image. Additionally, the browser may prepare and send a message over the Internet to the website containing the prohibited image source URL as well as the gTLD registration authority identifying the page containing the prohibited image source URL.

Similarly, hypertext links are commonly placed in content that contain URLs linking to other pages. Since the browser checks to confirm that all content accessed is located on the .kids gTLD, an <href> tag must contain only links to content contained within the .kids gTLD. If an <href> tag is found that links to content outside of the .kids gTLD, the browser will not retrieve the external content, and additionally may prepare and send a message over the Internet to the website containing the prohibited link as well as the gTLD registration authority identifying the page containing the prohibited link.

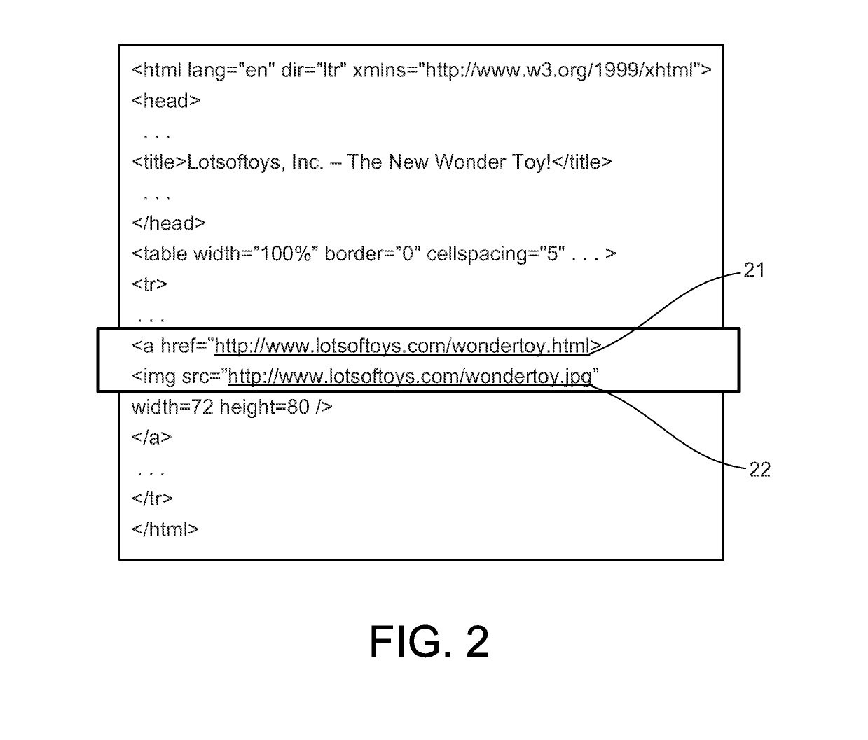

FIG. 2 shows an example of HTML code processed by the Internet browser that contains HTML tags to prohibited content. When the browser retrieves the HTML code in FIG. 2, it parses the HTML code to check all HTML tags for URLs outside of the .kids gTLD. In the example shown in FIG. 2, the browser will detect the prohibited link 21, http://www.lotsoftoys.com/wondertoy.html. The browser does not need to change the appearance of the prohibited link, only to deny access to the link if selected by the user. However, the browser may change the color of the displayed link to indicate that access to it is disabled. It may also signal detection of the prohibited link by sending a message identifying the prohibited link and the Web page on which it was detected to the owner of the Web site and/or the registration authority.

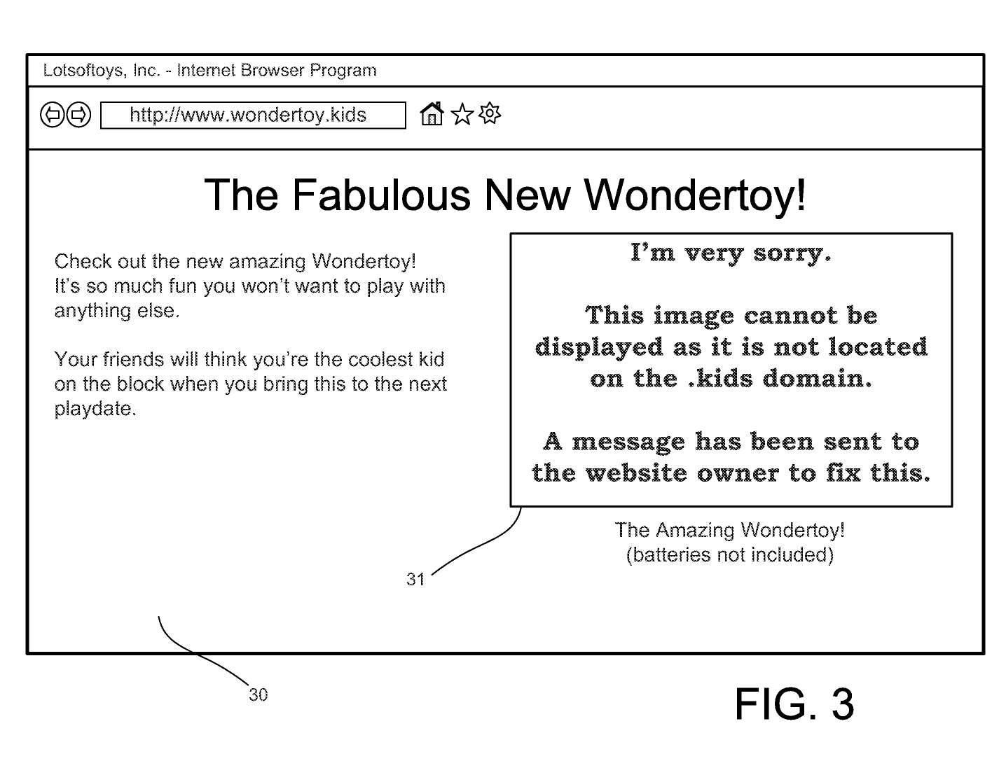

Also in FIG. 2 is a prohibited image link 22, http://www.lotsoftoys.com/wondertoy.jpg. In this case, the browser does need to change the appearance of the image, since a box containing the prohibited image has been reserved in the layout of the page containing the prohibited image. FIG. 3 illustrates a sample screen display 30 in a web browser window. Warning box 31 has been substituted for the image not contained within the permitted gTLD. The browser may also signal detection of the prohibited link by sending a message identifying the prohibited link and the Web page on which it was detected to the owner of the Web site and/or the registration authority.

The browser's notification of the detection of prohibited URLs may occur within the HTTP protocol (using the POST command, for example), or using more elaborate methods external to the HTTP protocol, such as electronic mail or text messaging protocols.

Another application of the present invention is to provide a company with the ability to limit access to the Internet by both its employees using company-supplied computers, and by its customers, who may be browsing the company's content on company-supplied kiosk computers that may be in the company's retail store locations or situated in a retailer that is selling the company's products. In addition to registering “lotsoftoys.com”, the Lots of Toys Corporation would register the .lotsoftoys domain. Each computer for which restricted access is desired would have installed the specially-modified Internet browsing program described previously.

For employees, the .lotsoftoys domain may provide access to various Intranet-type assets, such as electronic mail, financial, or other applications, and may implement HTTP Secure in order to prevent access to those assets by unauthorized personnel. In addition, as sometimes it is desirable to provide employees access to publicly-available information created by third parties, such desirable information can be mirrored on the .lotsoftoys website in order that it can be made accessible to employees using the specially-modified Internet browsing program.

A customer using a Lots of Toys Corporation kiosk in a retail environment would be similarly constrained to sites located within the .lotsoftoys domain. Typing addresses outside of the .lotsoftoys domain will have no effect, as the browser will not retrieve and display any content located out of the selected gTLD. This prevents the kiosk from being used to browse inappropriate content, or from being navigated to sites that may download harmful software to the kiosk computer.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features.

Variations of embodiments of the present invention that are described and embodiments of the present invention comprising different combinations of features noted in the described embodiments will occur to persons of the art.

What is claimed is:

1. A system for restricting access to the Internet comprising:
a selected generic top-level domain;
a registration authority controlling the content of web sites that may be placed on said selected generic top-level domain; and
a specially-modified Internet browser software program that limits access solely to URLs located within said selected generic top-level domain by retrieving and displaying content only from URLs located within said selected generic top-level domain.

2. The system of claim 1, where said specially-modified Internet browser software program displays an error message if a URL that is not located within said generic top-level domain is requested.

3. The system of claim 1, where said specially-modified Internet browser software program displays an error message if an HTML tag containing a URL that is not located within said generic top-level domain is found within content that is located within said generic top-level domain.

4. The system of claim 3, where said specially-modified Internet browser software program transmits an error message to the webmaster of the website containing an HTML tag containing a URL that is not located within said generic top-level domain.

5. The system of claim 3, where said specially-modified Internet browser software program transmits an error message to said registration authority.

6. A method for restricting access to the Internet comprising:
establishing a selected generic top-level domain;
controlling the content of web sites placed on said generic top-level domain; and
producing and distributing a specially-modified Internet browser software program that limits access solely to URLs located within selected generic top-level domain by retrieving and displaying content only from URLs located within said selected generic top-level domain.

7. The method of claim 6, including the additional step of parsing content of URLs on said selected generic top-level domain to detect HTML tags containing URLs pointing to content not contained within said generic top-level domain and blocking access to said detected HTML tags.

8. The method of claim 7, including the additional step of notifying the web site when HTML tags to content not contained within said generic top-level domain are detected.
